(19) United States
(12) Patent Application Publication
(10) Pub. No.: US 2008/0212312 A1
(43) Pub. Date: Sep. 4, 2008

(54) Lice Extermination System and Method

(75) Inventors: Lori Kaufinann, Ra'ananna (IL); Ram Oron, Nes Ziona (IL); Ariela Donval, Rosh Haayin (IL); Doron Nevo, Ra'ananna (IL); Moshe Oron, Rehovot (IL)

Correspondence Address: DARBY & DARBY P.C., P.O. BOX 770, Church Street Station, New York, NY, 10008-0770, US

(73) Assignee: Y.K. HOLDINGS LTD., Ra'ananna (IL)

(21) Appl. No.: 12/064,168

(22) PCT Filed: Aug. 17, 2006
(86) PCT No.: PCT/IL06/00964

§ 371 Date: May 5, 2008

Related U.S. Application Data
(60) Provisional application No. 60/709,353, filed on Aug. 17, 2005.
(60) Provisional application No. 60/715,545, filed on Sep. 8, 2005.
(60) Provisional application No. 60/771,937, filed on Feb. 8, 2006.

(51) Int. Cl. F21V 33/00

(52) U.S. Cl. 362/109

(57) ABSTRACT

Apparatus (10) is provided for treating an infested area (27) of a subject, the apparatus including a housing (20), and an illumination unit (22), which is coupled to the housing (20) and includes a light source (28) configured to emit light having an emission spectrum selected from the group consisting of: visible light and infrared light, which spectrum is better absorbed by an infestation of the area (27) than by tissue of the subject, the infestation including at least one infestation selected from the group consisting of: lice, and lice eggs, and the tissue including at least one tissue selected from the group consisting of: skin of the subject, and hair of the subject. The apparatus (10) further includes an optical guide unit (24), coupled to the housing (20), and configured to distribute the light to the area (27). Other embodiments are also described.

### CROSS-REFERENCES TO RELATED APPLICATIONS

The present application claims the benefit of: (a) U.S. Provisional Patent Application 60/709,353, filed Aug. 17, 2005, (b) U.S. Provisional Patent Application 60/715,545, filed Sep. 8, 2005, and (c) U.S. Provisional Patent Application 60/771,937, filed Feb. 8, 2006, all of which are assigned to the assignee of the present application and are incorporated herein by reference.

### FIELD OF THE INVENTION

The present invention relates generally to treating insect infestations, and specifically to methods and apparatus for exterminating lice.

### BACKGROUND OF THE INVENTION

Human pediculosis is the infestation of the human scalp, body or pubic area with lice. Head lice lay eggs on the hair of the head. From the eggs hatch nymphs, which mature into adult lice. Lice infestations are conventionally treated with chemicals, such as shampoos, lotions, and creams containing various insecticides such as lindane, malathion, or permethrin, which generally kill the lice but not the eggs. Following treatment with these chemicals, the eggs are manually removed by careful examination of the affected area. In order for chemical treatment to be potentially effective, it generally must be repeated at least once, in order to exterminate lice that hatch from eggs that were overlooked during the manual egg removal. Lice are increasingly developing resistance to commonly used chemicals.

To overcome the difficultly of manually removing lice, eggs, and nits, numerous lice combs have been developed, including combs with finely spaced teeth, and combs with teeth having particular shapes (e.g., widening at the base, or diamond shaped). Some combs incorporate a magnifying glass to aid in finding eggs. Some combs incorporate an adhesive strip or spots that trap lice. Some combs incorporate a motor to coordinate vibration or meshing of teeth for ease of passage through hair, detangling of hair, and/or injuring lice. Some combs include a heating element for heating the teeth, in order to kill lice trapped between the teeth.

Some combs include a vacuum attachment for removing lice and fleas, guide lice to an adhesive strip in order to trap them, and/or guide lice through an insecticide-impregnated filter. Some combs include an electrocution device for remote electrocution of lice. Some combs include a rotating brush which brushes animal fleas onto an insecticide-impregnated sponge. Some combs have hollow teeth, through which the comb dispenses steam or hot air to the hair root, or an insecticide (see, for example, European Patent Application EP 1 002 477 A1 to Lorenzo, which is incorporated herein by reference). Some combs emit ultraviolet radiation designed to disinfect the head from pests and fungi.

Epilady® 2000, L.L.C. (Hatzor Haglilit, Israel) markets the Robi™ Comb Pro, an electronic lice comb that electrocutes lice. The company describes the comb as having two operation modes, one for lice detection and the other for lice extermination. Similarly, U.S. Pat. No. 5,318,051 to Koppel, which is incorporated herein by reference, describes the use of an electric current to remove lice and nits.

U.S. Pat. No. 6,053,180 to Kwan, which is incorporated herein by reference, describes a UV light-emitting source in or adjacent to the styling portion of a hair and/or animal fur care or styling appliance. The UV light-emitting source is described as capable of facilitating the killing of micro-organisms including spores, virus, fungus, bacteria and lice residing on hair and/or fur as well as on the appliance itself.

U.S. Pat. No. 5,353,817 to Kantor et al., which is incorporated herein by reference, describes a hand-held hair grooming device comprising a housing adapted to be held in the hand of the user, an array including a plurality of electrically conductive tines extending outwardly from the housing, apparatus for mounting the plurality of tines in the housing, apparatus for applying an electric potential between adjacent times whereby lice or other pests suitably disposed between adjacent tines are electrocuted, and apparatus for selectable displacement of some of the plurality of tines relative to others of said plurality of tines to assist in cleaning thereof.

U.S. Pat. Nos. 5,072,746 and 5,178,168 to Kantor, which are incorporated herein by reference, describe a hand-held hair grooming device comprising a housing adapted to be held in the hand of the user, an array of electrically conductive tines extending outwardly from the housing, apparatus for mounting the tines in the housing, and apparatus for applying an electric potential between adjacent tines whereby lice or other pests suitably disposed between adjacent tines are electrocuted.

U.S. Pat. No. 5,078,157 to Golan et al., which is incorporated herein by reference, describes apparatus for treating hair including a handle, hair separation apparatus associated with the handle and extending longitudinally along an axis, apparatus for oscillating the hair separation apparatus about the axis so as to bring the hair separation apparatus into repeated engagement with a group of hairs so as to ease passage of the separation apparatus therethrough, and apparatus for preventing the hair separation apparatus from striking a portion of skin to which the hairs are attached. The hair separation apparatus is oscillated about the axis at a relatively high frequency, of, typically, greater than 4,000 cycles per minute and preferably greater than 10,000 cycles per minute, and at a relatively small amplitude, of, typically, no larger than about 5 degrees and, preferably, no larger than 2 degrees.

U.S. Pat. No. 5,628,332 to Debourg et al., which is incorporated herein by reference, describes techniques for destroying parasites present in a mass of hair or fur growing from a skin surface, the device comprising a handling body; a comb fixed to the body and comprising of a plurality of teeth, the teeth having portions adapted to be displaced through the mass of hair or fur when the device is in use; and a source of energy for at least locally raising the temperature of the hair or fur when the teeth are displaced through the mass of hair or fur, wherein at least part of the portions of the teeth are thermally conductive and are operatively associated with a source of energy for supplying sufficient heat energy to destroy parasites on the hair or fur which is in contact with the portions.

U.S. Pat. No. 6,685,969 and U.S. Patent Application Publication 2004/0126403 to Van Scoik et al., which are incorporated herein by reference, describe the removal of ectoparasites, such as fleas, ticks, mites and lice, from a human or animal host by applying a composition that causes the temperature of a treated area to become higher or lower than normal. In one embodiment, treatment is effected by applying a composition that releases heat when contacted with water. The elevated or decreased temperature immobilizes the parasites and facilitates their mechanical removal, such as by combing.

U.S. Pat. No. 6,689,394 to Van Scoik et al., which is incorporated herein by reference, describes the removal of ectoparasites, such as fleas, ticks, mites and lice, from a human or animal host by applying a composition to the affected area that causes desiccation of the organism. In one embodiment, treatment is effected by applying a substantially anhydrous composition that has a strong affinity for water. As the composition hydrates, it desiccates the pests and facilitates their mechanical removal, such as by combing.

U.S. Pat. Nos. 6,875,421, 6,440,388, and 5,997,846 to Burns et al., which are incorporated herein by reference, describe a method for detecting chitin-containing organisms on an area of a person or animal by contacting the particular area with a dye that is capable of binding to chitin and emitting fluorescence upon exposure to light. If a chitin-containing organism is present in the treated area, the chitin of the organism binds the dye and, upon exposure to light, the chitin-containing organisms may be visualized and removed.

U.S. Pat. Nos. 6,541,455, 6,350,734, 6,303,581, and 6,265,384 to Pearlman, which are incorporated herein by reference, describe methods and kits for removing, treating, or preventing head lice infestations, including topically applying to the lice-infested area an effective amount of a dryable pediculostatic agent for a time sufficient to immobilize the lice, drying the agent onto the application site, and removing the dried agent, thereby removing the lice and nits.

U.S. Pat. No. 5,261,427 to Dolev, which is incorporated herein by reference, describes a lice comb device constructed as a portable, hand-held housing containing a blower heater, to heat and direct a stream of heated air toward a set of comb teeth attached to the housing. Each of the comb teeth is formed with a hollow cavity having an opening at its end. The heated air stream is directed via the comb tooth and exits at the opening, where it is deflected away from the scalp by a concave surface, so that it impinges on lice and lice eggs attached near the hair root. The temperature of the heated air destroys the lice and lice eggs.

U.S. Pat. No. 5,972,987 to Reid et al., which is incorporated herein by reference, describes a method for removing lice eggs from the hair of an infested human or animal using a nit-visualizing composition. The composition involves the use of certain dyes which have an affinity to the surface of nits, thereby enabling a second individual to more easily see and remove the eggs during a combing or other removal process. A colored material is dispersed within a water- or alcohol-based solvent and, in one embodiment, a liquefied propellant as well. The composition is applied to the hair of the infested human or animal, and then removed after drying by a process of brushing or washing. The colored material which adsorbs to the chitinous exoskeleton and binding cement of the lice eggs remains on the nits, thereby facilitating visual identification and removal of the lice eggs from hair.

U.S. Pat. No. 5,997,847 to Spiesel, which is incorporated herein by reference, describes a method for detecting the infestation of a host by arthropod ectoparasites using a fluorescent dye which stains the ectoparasites and/or their eggs but not the adjacent skin or hair to which they are attached. The dye can be incorporated into a shampoo or a rinsing solution and is applied to the scalp or other region of the host. After a suitable period of time has elapsed, the dye-containing solution or shampoo is rinsed off and the hair and adjacent area of the host examined under ultraviolet or near-ultraviolet light. Such illumination will cause the stained ectoparasites and/or eggs to glow and, thus, become easily detectable for diagnosis and subsequent removal. The method may be applied to detect scabies (i.e. skin-burrowing mites), head lice, body and pubic lice and to any other arthropod ectoparasites and their eggs containing a substantial percentage of chitin.

### SUMMARY OF THE INVENTION

In embodiments of the present invention, a lice and eggs extermination device comprises a housing, an optical guide, and a light source having an emission spectrum that is better absorbed by living lice and/or eggs than by human or animal skin and hair. Typically, the emission spectrum is selected for relatively high absorption by chitin, a polysaccharide present in the exoskeleton of lice and eggs, but not in human or animal hair or skin. The optical guide is typically adapted to distribute the light from a plurality of directions, in order to provide uniform and thorough exposure of an infested area, even if the area is completely or partially shielded by hair. The emission spectrum typically includes a wavelength range within the visible or infrared (near, medium, or far) spectra. The extermination device is typically either hand-held or stand-alone. For some applications, the extermination device is incorporated into a comb, a helmet, gloves, or any other lice and eggs removal device.

There is therefore provided, in accordance with an embodiment of the present invention, apparatus for treating an infested area of a subject, the apparatus including:

a housing;

an illumination unit, coupled to the housing, and including a light source configured to emit light having an emission spectrum selected from the group consisting of: visible light and infrared light, which spectrum is better absorbed by an infestation of the area than by tissue of the subject, the infestation including at least one infestation selected from the group consisting of: lice, and lice eggs, and the tissue including at least one tissue selected from the group consisting of: skin of the subject, and hair of the subject; and

an optical guide unit, coupled to the housing, and configured to distribute the light to the area.

In an embodiment, the infestation includes both lice and eggs, and the light source is configured to emit the light having the emission spectrum that is better absorbed by the infestation than by the tissue.

For some applications, the apparatus includes a cooling unit, which is configured to remove excess heat generated by the light source. For some applications, the apparatus includes a comb, a head cover, and/or a glove, with which the optical guide unit is integrated. For example, the comb may include tines, and the optical guide unit may include light guides that are integrated into the tines. For some applications, the light source includes at least one lighting element selected from the group consisting of: an incandescent lighting element, a laser, and an LED. For some applications, the optical guide unit is configured to distribute the light from a plurality of directions.

In an embodiment, the emission spectrum has a wavelength between 0.5 and 10 microns, and the light source is configured to emit the light having the emission spectrum having a wavelength between 0.5 and 10 microns. For some applications, the emission spectrum has a wavelength between 6 and 7 microns, and the light source is configured to emit the light having the emission spectrum having a wavelength between 6 and 7 microns. Alternatively, for some applications, the emission spectrum has a wavelength between 3 and 3.5 microns, and the light source is configured to emit the light having the emission spectrum having a wavelength between 3 and 3.5 microns. Further alternatively, for some applications, the emission spectrum has a wavelength between 9 and 10 microns, and the light source is configured to emit the light having the emission spectrum having a wavelength between 9 and 10 microns. Still further alternatively, for some applications, the emission spectrum has a wavelength between 3 and 3.5 microns and between 6 and 7 microns, and the light source is configured to emit the light having the emission spectrum having a wavelength between 3 and 3.5 microns and between 6 and 7 microns.

There is also provided, in accordance with an embodiment of the present invention, apparatus for treating an infested area of a subject, the apparatus including:

a housing;

an illumination unit, coupled to the housing, and including a light source configured to emit light having an emission spectrum selected from the group consisting of: visible light and infrared light, which spectrum is better absorbed by chitin than by tissue of the subject; and

an optical guide unit, coupled to the housing, and configured to distribute the light to the area.

For some applications, the apparatus includes a cooling unit, which is configured to remove excess heat generated by the light source. For some applications, the apparatus includes a head cover, with which the optical guide unit is integrated. Alternatively, the apparatus includes a glove, with which the optical guide unit is integrated. Further alternatively, the apparatus includes a comb, with which the optical guide unit is integrated. For example, the comb may include tines, and the optical guide unit may include light guides that are integrated into the tines.

For some applications, the light source includes at least one lighting element selected from the group consisting of: an incandescent lighting element, a laser, and an LED. For some applications, the optical guide unit is configured to distribute the light from a plurality of directions.

In an embodiment, the emission spectrum has a wavelength between 0.5 and 10 microns, and the light source is configured to emit the light having the emission spectrum having a wavelength between 0.5 and 10 microns. For some applications, the emission spectrum has a wavelength between 6 and 7 microns, and the light source is configured to emit the light having the emission spectrum having a wavelength between 6 and 7 microns. Alternatively, the emission spectrum has a wavelength between 3 and 3.5 microns, and the light source is configured to emit the light having the emission spectrum having a wavelength between 3 and 3.5 microns. Further alternatively, the emission spectrum has a wavelength between 3 and 3.5 microns and between 6 and 7 microns, and the light source is configured to emit the light having the emission spectrum having a wavelength between 3 and 3.5 microns and between 6 and 7 microns. Still further alternatively, the emission spectrum has a wavelength between 9 and 10 microns, and the light source is configured to emit the light having the emission spectrum having a wavelength between 9 and 10 microns.

In an embodiment, the apparatus includes a component configured to facilitate application of the emitted light to the infestation by moving the hair of the subject. For example, the component may be configured to raise and/or separate the hair of the subject. For some applications, the component includes a comb, a single-port suction applicator, a multi-port suction applicator, a flexible fastener, and/or one or more hair clips.

There is further provided, in accordance with an embodiment of the present invention, a method for treating a subject, the method including:

identifying an infestation of an area of the subject, the infestation including at least one infestation selected from the group consisting of: lice, and lice eggs;

emitting light having an emission spectrum selected from the group consisting of: visible light and infrared light, which spectrum is better absorbed by the infestation of the area than by tissue of the subject, the tissue including at least one tissue selected from the group consisting of: skin of the subject, and hair of the subject; and

distributing the light to the area.

There is additionally provided, in accordance with an embodiment of the present invention, a method for treating a subject, the method including:

identifying an infestation of an area of the subject;

emitting light having an emission spectrum selected from the group consisting of: visible light and infrared light, which spectrum is better absorbed by chitin than by tissue of the subject; and

distributing the light to the area.

In an embodiment, distributing the light includes facilitating application of the emitted light to the infestation by moving the hair of the subject, e.g., raising and/or separating the hair. For some applications, moving the hair includes moving the hair using a comb, applying suction to the hair using a single- or multi-port suction applicator, transiently binding the hair to a flexible fastener, and/or moving the hair using one or more hair clips.

The present invention will be more fully understood from the following detailed description of embodiments thereof, taken together with the drawings, in which:

### BRIEF DESCRIPTION OF THE DRAWINGS

FIG. 1 is a schematic block diagram of a lice and eggs extermination system, in accordance with an embodiment of the present invention;

FIG. 2 is a graph showing a transmittance spectrum of chitin, for use in accordance with an embodiment of the present invention;

FIGS. 3A and 3B are schematic cross-sectional illustrations of a light source of the system of FIG. 1, in accordance with respective embodiments of the present invention;

FIGS. 4A and 4B are schematic cross-sectional illustrations of an illumination unit of the system of FIG. 1, in accordance with respective embodiments of the present invention;

FIG. 5 is a schematic illustration of a configuration of an optical guide unit of the system of FIG. 1, in accordance with an embodiment of the present invention; and

FIG. 6 is a schematic illustration of the system of FIG. 1, comprising a head cover, in accordance with an embodiment of the present invention.

### DETAILED DESCRIPTION OF EMBODIMENTS

FIG. 1 is a schematic block diagram of a lice and eggs extermination system 10, in accordance with an embodiment of the present invention. System 10 comprises a housing 20, an illumination unit 22, an optical guide unit 24, and a power supply 26. Optical guide unit 24 distributes light, symbolically represented by rays 44, to an infested area 27, such as a head of a subject.

Illumination unit 22 comprises at least one light source 28, which typically comprises at least one incandescent light source, at least one laser, and/or at least one LED. For some applications, such as in which light source 28 comprises an incandescent light source, illumination unit 22 further comprises at least one optical filter 30, which allows passage of only one or more desired spectral bands. Filter 30 is typically not necessary for applications in which light source 28 comprises a laser, which emits light of a selected wavelength. Illumination unit 22 provides the light either in pulses or substantially continuously. For some applications, system 10 comprises a cooling unit 32, such as a blower or water cooling system, to remove excess heat generated by light source 28.

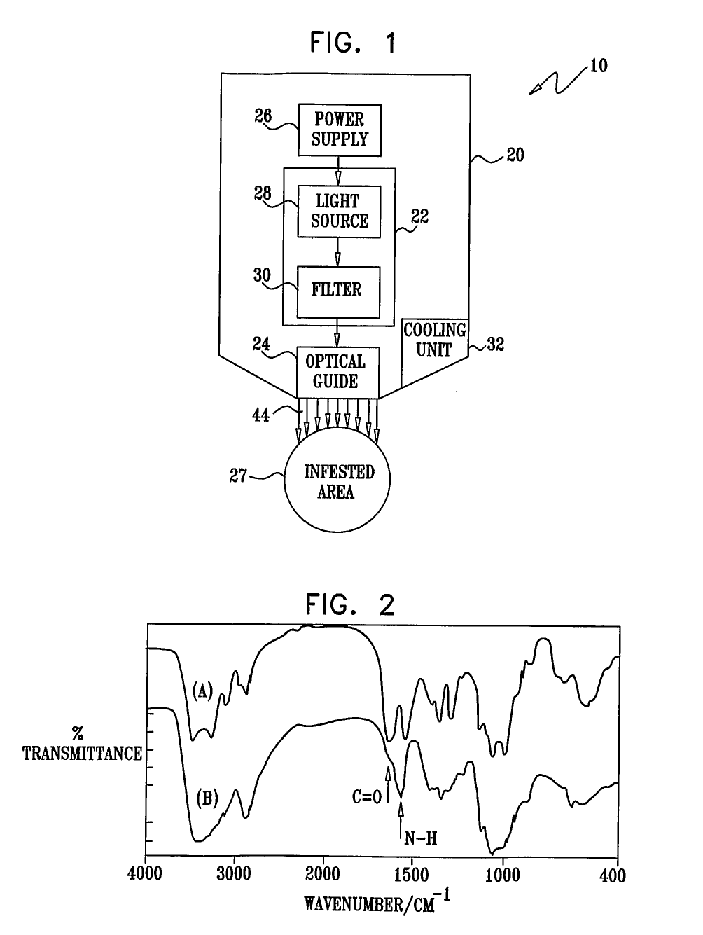

Reference is made to FIG. 2, which is a graph showing a transmittance spectrum of chitin, measured in accordance with an embodiment of the present invention. Illumination unit 22 is configured to emit light having an emission spectrum that is better absorbed by lice and/or eggs than by human or animal tissue, such as skin and hair. Typically, the emission spectrum is selected for relatively high absorption by chitin, a polysaccharide present in the exoskeleton of lice and eggs, but not in human or animal hair or skin. Therefore, the emission spectrum is typically better absorbed by the infestation than by tissue of the subject. Typically, the illumination is set to a level that is sufficient to exterminate lice and/or eggs, but insufficient to cause pain or tissue damage to the subject.

The following table highlights several of the peaks in the transmittance spectrum of the graph of FIG. 2:

TABLE 1

| Peak | Wavenumber | Wavelength | % Trans- |
|---|---|---|---|
| # | [cm [symbol] −1] | [microns] | mittance |
| 1 | 3305.9 | 3.026 | 13.7 |
| 2 | 2963.1 | 3.375 | 14.3 |
| 3 | 2929.6 | 3.414 | 14.6 |
| 4 | 1650.3 | 6.06 | 10.0 |
| 5 | 1538.5 | 6.5 | 11.6 |
| 6 | 1396.4 | 7.161 | 15.0 |
| 7 | 1000.0 | 10.0 | 23.0 |

The emission spectrum of light emitted by system 10 is either discrete or continuous, and typically includes a wavelength range within the visible or infrared (near, medium, or far) spectra. For example, the wavelength range may fall between about 0.5 and about 10 microns, such as between about 3 and about 3.5 microns, between about 6 and about 7 microns, and/or between about 9 and about 10 microns.

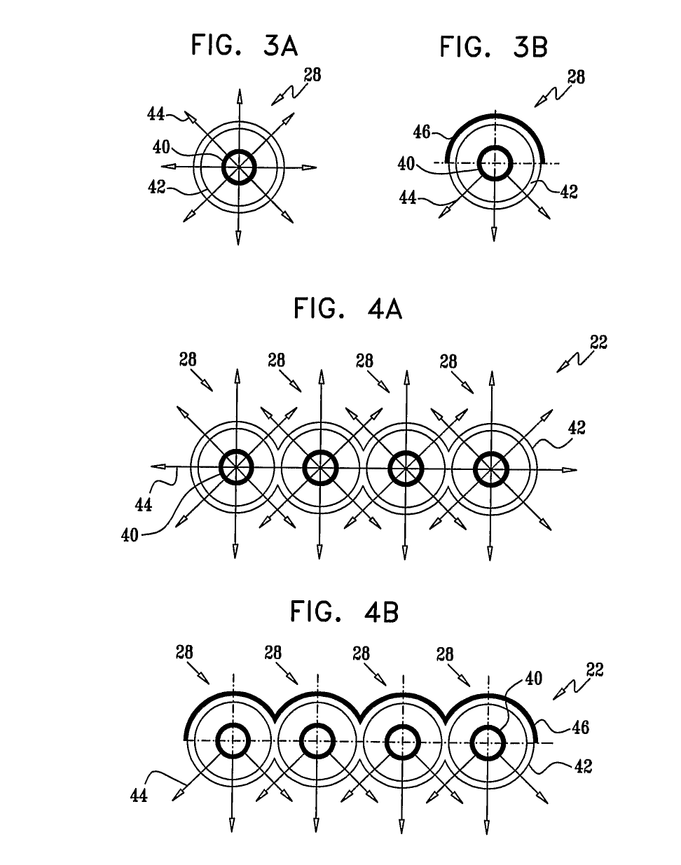

FIGS. 3A and 3B are schematic cross-sectional illustrations of light source 28, in accordance with respective embodiments of the present invention. In these embodiments, light source 28 comprises an incandescent light source, which is heated to a temperature appropriate for emitting the selected emission spectrum. The incandescent light source comprises a filament 40, which comprises, for example, tungsten, tantalum, or molybdenum, and which is coiled (e.g., as a spiral) and heated by an electrical current. Filament 40 is surrounded by a tube 42, which comprises infrared-transparent material, such as quartz, silicon, gallium arsenide (GaAs), germanium, or sapphire. For example, light source 28 may comprise Medium Wave twin-tube emitter or Short Wave emitter “Quatro” No. 45131608, both manufactured by Heraeus Holding GmbH (Hanau, Germany), and system 10 may comprise cooling unit 32, such as a blower or water cooling system. In the unshielded configuration shown in FIG. 3A, light source 28 transmits light, symbolically represented by rays 44, in all directions. In the configuration shown in FIG. 3B, light source 28 further comprises a coating 46 that covers a portion of tube 42, such that light is transmitted in only a portion of directions, in a half-circle. Coating 46 is typically reflective, and comprises, for example, gold, aluminum, or silver.

FIGS. 4A and 4B are schematic cross-sectional illustrations of illumination unit 22, in accordance with respective embodiments of the present invention. In the embodiment shown in FIG. 4A, illumination unit 22 comprises a plurality of unshielded light sources 28, such as described hereinabove with reference to FIG. 3A. In the embodiment shown in FIG. 4B, illumination unit 22 comprises a plurality of shielded light sources 28, such as described hereinabove with reference to FIG. 3B. The configurations shown in FIGS. 4A and 4B are typically used when a single light source 28 is insufficient to supply the required energy.

Reference is again made to FIG. 1. Light emitted from illumination unit 22 passes through optical guide unit 24, which is typically adapted to distribute incoming light from a plurality of directions, in order to provide uniform (i.e., uniform energy density (watts/cm2)) and thorough exposure of infested area 27, even when the area is shielded by hair. Optical guide unit 24 comprises either image-forming optics or non-image-forming optics.

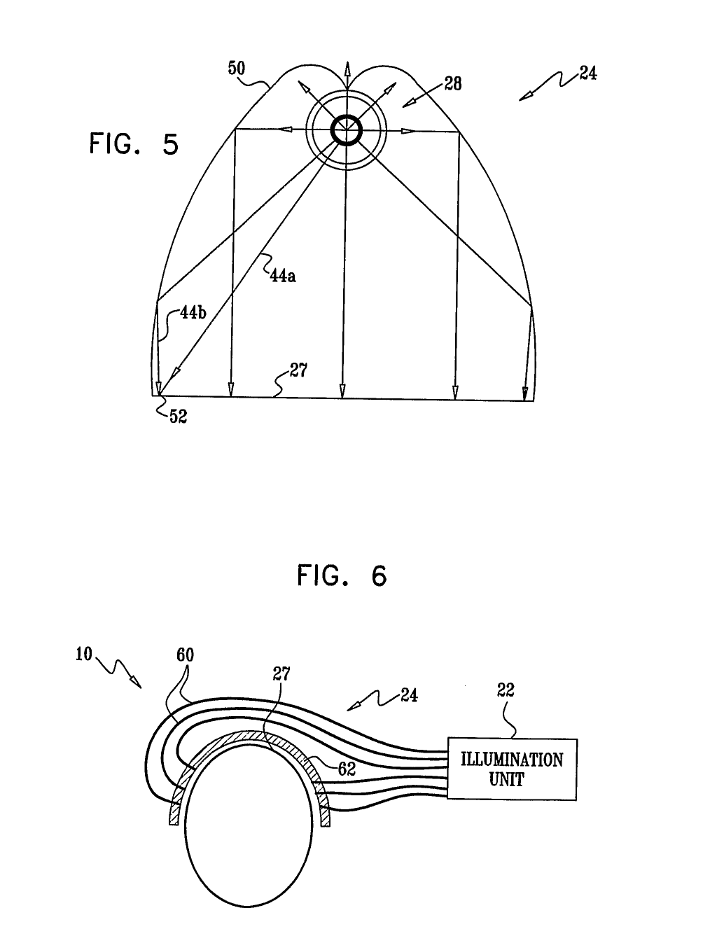

Reference is made to FIG. 5, which is a schematic illustration of a configuration of optical guide unit 24, in accordance with an embodiment of the present invention. In this embodiment, optical guide unit 24 comprises a non-imaging optical illuminator 50, configured to distribute light of lamp 28 substantially uniformly on infested area 27. For example, light rays 44a and 44b reach a point 52 from different directions. Because the light reaches substantially all points of infested area 27 from a plurality of directions, the light typically reaches areas that may be shielded in one or more directions by an obstacle, such as hair.

Reference is made to FIG. 6, which is a schematic illustration of an embodiment of system 10 in which optical guide unit 24 comprises one or more optical fibers 60. In this embodiment, system 10 comprises a head cover 62, adapted to surround at least a portion of infested area 27, which is typically a head of the subject. Head cover 62 is typically shaped like a helmet.

In an embodiment of the present invention, system 10 is configured to supply light having a flux of between about 0.08 and about 0.24 watts/cm2 over the 1 to 7 micron wavelength region, with a peak value at about 2.5 micron (medium wave emitter). In an embodiment, system 10 is configured to supply light having a flux of between about 0.23 and about 0.46 watts/cm2 over the 0.5 to 5 micron wavelength region, with a peak value at about 1.2 microns (short wave emitter).

The following table shows results of a lice mortality experiment, performed in accordance with an embodiment of the present invention:

TABLE 2

| Experi- | | | Light | | | |
|---|---|---|---|---|---|---|
| mental | | Filter | flux | Time | Mortality [%] | |
| Group | Lamp | [On/Off] | [W/cm2] | [min] | Lice | Eggs |
| 1 | Short IR | Off | 0.45 | 2 | 100 | 100 |
| 2 | Medium IR | Off | 0.11 | 3 | 100 | 100 |
| 3 | Medium IR | On | 0.08 | 3 | 100 | 100 |

In experimental group 1, ten lice and ten eggs were simultaneously exposed to continuous light from a short wave emitter which emitted light over the 0.5 to 5 micron wavelength region, with a peak value at about 1.2 microns. In experimental groups 2 and 3, ten lice and ten eggs were exposed to continuous light from a medium wave emitter which emitted light over the 1 to 7 micron wavelength region, with a peak value at about 2.5 microns. In experimental group 3, an additional band pass filter for the range of 2.8 um to 3.8 um was placed between the emitter and the lice and eggs. Each of the experimental groups included a control group of ten lice and ten eggs. The control lice and eggs were not exposed to light from the emitters, and had between a 0% and a 10% mortality rate in all three groups. It is noted that the level of exposure in experimental groups 2 and 3 is less than or equal to the maximum permissible exposure (MPE) levels generally allowed by health standards.

In an embodiment of the present invention, housing 20 is adapted to function as a handle for system 10. Alternatively, system 10 is adapted to be stand-alone. For some applications, system 10 is incorporated into a comb, a helmet, gloves, or any other lice and eggs removal device. For example, system 10 may comprise gloves, and illumination unit may comprise one or more LEDs. For some applications, optical guide unit 24 comprises light guides that are incorporated into a comb, such as into tines of the comb. Alternatively or additionally, system 10 comprises a hair-raising and/or hair-separation component, to facilitate application of the light to the infestation. For example, the component may comprise a comb, a single-port or multi-port suction applicator, a flexible fastener that can bind to hair (e.g., Velcro), one or more hair clips, or apparatus described in the above-referenced U.S. Pat. No. 5,078,157 to Golan et al., which is incorporated herein by reference.

In an embodiment of the present invention, techniques and apparatus described herein are combined with lice and egg extermination techniques and apparatus described in one or more of the patents and patent application publications described in the Background of the Invention section hereinabove.

Although system 10 has been described herein as appropriate for treating lice infestation, the system may also be used for treating other ectoparasites, such as fleas, ticks, mites, and scabies. Additionally, it is noted that methods and apparatus described herein are generally applicable to ectoparasitic infestations affecting both humans and animals.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. Apparatus for treating an infested area of a subject, the apparatus comprising:
a housing;
an illumination unit, coupled to the housing, and comprising a light source configured to emit light having an emission spectrum selected from the group consisting of: visible light and infrared light, the emission spectrum having a wavelength between 0.5 and 10 microns, which spectrum is better absorbed by an infestation of the area than by tissue of the subject, the infestation including at least one infestation selected from the group consisting of: lice, and lice eggs, and the tissue including at least one tissue selected from the group consisting of: skin of the subject, and hair of the subject; and
tines, coupled to the housing, and configured to facilitate illumination of the area by the illumination unit.

2. The apparatus according to claim 1, wherein the infestation includes both lice and eggs, and wherein the light source is configured to emit the light having the emission spectrum that is better absorbed by the infestation than by the tissue.

3. (canceled)

4. The apparatus according to claim 1, further comprising a head cover, configured to facilitate illumination of the area.

5-10. (canceled)

11. The apparatus according to claim 1, wherein the emission spectrum has a wavelength between 6 and 7 microns, and wherein the light source is configured to emit the light having the emission spectrum having a wavelength between 6 and 7 microns.

12-13. (canceled)

14. The apparatus according to claim 1, wherein the emission spectrum has a wavelength between 9 and 10 microns, and wherein the light source is configured to emit the light having the emission spectrum having a wavelength between 9 and 10 microns.

15-35. (canceled)

36. A method for treating a subject, the method comprising:
identifying an infestation of an area of the subject, the infestation including at least one infestation selected from the group consisting of: lice, and lice eggs;
emitting light having an emission spectrum selected from the group consisting of: visible light and infrared light, the emission spectrum having a wavelength between 0.5 and 10 microns, which spectrum is better absorbed by the infestation of the area than by tissue of the subject, the tissue including at least one tissue selected from the group consisting of: skin of the subject, and hair of the subject; and
facilitating application of the emitted light to the infestation by moving the hair of the subject.

37. The method according to claim 36, wherein the infestation includes both lice and eggs, and wherein identifying the infestation comprises identifying the infestation including both lice and eggs. cm 38. (canceled)

39. The method according to claim 36, wherein facilitating the application comprises placing a head cover around at least a portion of the infest area, and facilitating the application using the head cover.

40-45. (canceled)

46. The method according to claim 36, wherein the emission spectrum has a wavelength between 6 and 7 microns, and wherein emitting the light comprises emitting the light having the emission spectrum having a wavelength between 6 and 7 microns.

47-48. (canceled)

49. The method according to claim 36, wherein the emission spectrum has a wavelength between 9 and 10 microns, and wherein emitting the light comprises emitting the light having the emission spectrum having a wavelength between 9 and 10 microns.

50-63. (canceled)

64. The method according to claim 36, wherein moving the hair comprises raising the hair of the subject.

65. The method according to claim 36, wherein moving the hair comprises separating the hair of the subject.

66-70. (canceled)

71. The apparatus according to claim 1, wherein the tines are configured to facilitate application of the emitted light to the infestation by moving the hair of the subject.

72. The apparatus according to claim 71, wherein the tines are configured to raise the hair of the subject.

73. The apparatus according to claim 71, wherein the tines are configured to separate the hair of the subject.

74. The method according to claim 36, wherein facilitating the application of the emitted light comprises using tines to facilitate the application.
